(19) United States
(12) Patent Application Publication
(10) Pub. No.: US 2026/0220172 A1
(43) Pub. Date: Jul. 30, 2026

(54) Generating Synthetic Conversation Data for Training and Evaluation of Natural Language Models

(71) Applicant: Google LLC, Mountain View, CA (US)

(72) Inventors: Harsh Lara, Mountain View, CA (US); Luke Beck Friedman, Mountain View, CA (US); Sameer Ahuja, Sunnyvale, CA (US); Manoj Kumar Tiwari, Santa Clara, CA (US)

(21) Appl. No.: 19/142,564

(22) PCT Filed: Dec. 22, 2022
(86) PCT No.: PCT/US2022/053882

§ 371 Date: Jun. 23, 2025

(51) Int. Cl. G06F 16/3329; G06N 3/08

(52) U.S. Cl. CPC G06F 16/33295; G06N 3/08

(57) ABSTRACT

Generally, the present disclosure is directed to methods and systems for automatically generating data that encodes natural language conversations between at least two parties. The conversational data may be automatically generated by one or more language generative models. As such, the automatically generated conversational data may be referred to as synthetic conversational data. The synthetic conversational data may simulate the speech patterns (e.g., prompts, responses to prompts, and combinations thereof) of one or more hypothetical or real humans (e.g., users) participating a conversation. In various applications, the synthetic conversational data is employed to train, pre-train, fine-tune, and/or evaluate the performance of at least one of the generative language models employed to generate the synthetic conversational data and/or other generative language models. Such other generative language models may be employed in various interactive recommendation systems, chat-bots, or any other application that interacts with one

### FIELD

The present disclosure relates generally to natural language models. More particularly, the present disclosure relates to the automatic generation of synthetic conversation data for the training and evaluation of natural language models employed in recommendation systems.

### BACKGROUND

Recommendation (or recommender) systems are one of the most prominent success stories of machine learning in industry, serving billions of users over a wide range of domains such as searching for videos, news, and shopping. Despite this practical impact, most large-scale recommender systems still suffer from a lack of transparency and offer limited opportunity for users to exhibit control over their recommendations and engage in exploration over a sequence of interactions. Conversational recommender systems (e.g., interactive chat-bots) address these shortcomings by giving the user a real-time means to communicate with the system and make it less reliant on implicit interaction signals, such as clicks to infer preferences. However, training conversational recommender systems may require significant amounts of ground-truth labeled training data that include large numbers of interactive conversations between chat-bots and users. It may be very cumbersome to acquire training datasets of sufficient volume and with sufficient variance to train chat-bots that are generalizable enough to employ in recommendation systems.

### SUMMARY

Aspects and advantages of embodiments of the present disclosure will be set forth in part in the following description, or can be learned from the description, or can be learned through practice of the embodiments.

One example aspect of the present disclosure is directed to a method that includes providing a first conversation topic of a set of conversation topics to a first generative language model. The first generative model may be implemented by a computing system. A first synthetic conversational dataset may be generated at and/or by the computing system.

The synthetic conversational dataset may encode a first natural language (NL) conversation between the first generative language model and a second generative language model implemented by the computing system. In some embodiments, the first generative language model may be implemented by a user simulator implemented that is by the computing system. The second generative language model may also be implemented by the computing system. The generated first NL conversation may include an ordered first set of NL phrases. The ordered first set of NL phrases may include that a first ordered subset of NL phrases and a second ordered subset of NL phrases. The first ordered subset of NL phrases may be generated by the first generative language model. The second ordered subset of NL phrases may be generated by the second generative language model. A first NL phrase of the first ordered subset of NL phrases may include the first conversation topic. A first NL phrase of the second ordered subset of NL phrases may be a response to the first NL phrase of the first ordered subset of NL phrases. In some embodiments, the first NL phrase of the first ordered subset may not be an initial NL phrase of the first ordered set of NL phrases. In some embodiments, a performance of the second generative language model may be evaluated by the computing system. Evaluating the performance of the second generative language model may be based on the first synthetic conversational dataset.

Another example aspect of the present disclosure is directed to updating a training of the second generative language model based on the first synthetic conversational dataset. Updating the training of the second language model may include training a new feature of the second generative language model.

Another example aspect of the present disclosure is directed to training a third generative language model based on the first synthetic conversational dataset.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs XXX according to example embodiments of the present disclosure.

FIG. 1B depicts a block diagram of an example computing device that performs XXX according to example embodiments of the present disclosure.

FIG. 1C depicts a block diagram of an example computing device that performs XXX according to example embodiments of the present disclosure.

FIG. 2A depicts a block diagram of an example synthetic conversational data generation system that is enabled to generate synthetic conversational datasets, according to example embodiments of the present disclosure.

FIG. 2B shows a first example of a synthetic conversational dataset generated by the synthetic conversational data generation system of FIG. 2A, according to various embodiments.

FIG. 2C shows a second example of a synthetic conversational dataset generated by the synthetic conversational data generation system of FIG. 2A, according to various embodiments.

FIG. 3 shows a first example of a preference chain and a second example of a preference chain, according to various embodiments.

FIG. 4A shows a first example intent trajectory and a second example intent trajectory, according to various embodiments

FIG. 4B shows combing the first and second example preference chains of FIG. 3 with the first and second example intent trajectories of FIG. 4A.

FIG. 5 depicts a flow chart diagram of an example method to generate synthetic conversation data, according to example embodiments of the present disclosure.

Reference numerals that are repeated across plural figures are intended to identify the same features in various implementations.

### DETAILED DESCRIPTION

### Overview

Generally, the present disclosure is directed to methods and systems for automatically generating data that encodes natural language conversations between at least two parties. The conversational data may be automatically generated by one or more language generative models. As such, the automatically generated conversational data may be referred to as synthetic conversational data. The synthetic conversational data may simulate the speech patterns (e.g., prompts, responses to prompts, and combinations thereof) of one or more hypothetical or real humans (e.g., users) participating a conversation. In various applications, the synthetic conversational data may be employed to train, pre-train, fine-tune, and/or evaluate the performance of at least one of the generative language models employed to generate the synthetic conversational data and/or other generative language models. Such other generative language models may be employed in various interactive recommendation systems, chat-bots, or any other application that interacts with one or more users by via conversational data.

More specifically, the embodiments include a user simulator. The user simulator may include one or more language models that interprets conversational data (e.g., generated by a conversational agent, another user simulator, and/or a human) and generates natural-language responses and/or prompts to the other conversational data. The other conversational data may be generated by a conversational agent (e.g., a chat-bot) to be evaluated. For example, the conversational agent may be a first party of a conversation and the user simulator may be a second party of the conversation. The combination of the conversational data generated by the conversational agent and the conversational data generated by the user simulate may be employed as evaluation data that is used to evaluate the performance of the conversational agent via one or more benchmarks.

Conventional means for evaluating the performance of conversational agent typically involves a human manually interacting with the conversational agent to generate to generate such evaluation data. For an adequate evaluation and/or characterization of the performance of a conversational agent, large volumes of conversational data and large variances within the conversational data are required. As such, using humans to manually generate conversational data for evaluation purposes may not be scalable for generalizable conversational agents.

The synthetic conversational data may be employed as training data to train, pre-train, and/or fine-tune (pre-trained) conversational agents. Similar to the requirements for evaluation data, the volumes and variances required for training data to train generalizable conversational agents may render conventional techniques of employing humans to generate such training data unscalable. In contrast, the ability of quickly and inexpensively generating large volumes of and variances within synthetic conversational data, via the simulated user, renders the training, pre-training, and/or fine-tuning of generalizable conversational agents tractable, fast, and inexpensive.

The simulated user (e.g., a user simulator that simulates the user) may include a natural language understanding (NLU) model, a response generation model, and a natural language generation (NLG) model. The response generation model may include a preference model and an interaction model. One or more of these natural language processing (NLP) models may be “seeded” or “primed” to target (or “steer”) the conversation with the conversational agent towards one or more domains (e.g., areas of interest and/or topics). In addition to priming the user simulator via topics, the user simulator may be further configured via one or more preference chains and/or intent trajectories. Such priming or seeding with conversation topics, preference chains, intent trajectories, and/or combinations thereof serve to “guide” the generated synthetic conversation data via one or more conversation templates. Thus, priming a user simulator may enable the simulation of large volumes of real and/or hypothetical users.

To generate the synthetic conversational data, the user simulator may interact with another user simulator and/or a conversational agent. For instance, the user simulator may serve as a first party in the conversation and the conversational agent may serve as a second party in the conversation. In some embodiments, the conversation agent may be employ able in a recommendation system (e.g., a system to recommend content) and the user simulator may simulate a user that the recommendation system is recommending content to. In at least one embodiment, the conversation agent may be employable as a chat-bot (e.g., a chat-bot within a virtual assistant or a chat-bot for an automated “help” system.) and the user simulator may simulate a user that that is interacting with the chat bot. In at least one embodiment, both parties in the conversation may be enable by multiple implementations of the user simulator.

The NLU model of the user simulator is generally responsible for determining a semantic meaning (or understanding) of NL phrases generated by the conversational agent (or another implementation of the user simulator). The response generator model of the user simulator is generally responsible for determining a preference and an intent for a response to an NL phrase provided by the conversational agent (or another user simulator) based on the semantic understanding of the NL phrase, via a preference chain and/or an intent trajectory corresponding to the simulated user. More specifically, the preference model of the response generator model is generally responsible for determining a preference for the response based on the semantic understanding, a state of the conversation, and the preference chain provided to the preference model. The preference model of the response generator model may be referred to as a dialogue state tracking model and/or a conversation state tracking model. The interaction model of the response generator model is generally responsible for determining an intention of the response based on the semantic understanding, the determined preference and an intent of an intent trajectory provided to the interaction model. The NLG model of the user simulator generator is generally responsive for generating a response based on the semantic understanding of the input (e.g., semantic meaning), as well as the preferences and intents determined by the response generator model. The NLG model may also provide the generated response to the conversational agent and/or another user simulator.

Aspects of the present disclosure provide a number of technical effects and benefits. For instance, the embodiments may be employed to quickly, efficiently, and inexpensively generate synthetic conversational data. The synthetic conversational data may be employed to evaluate, train, pre-train, and/or fine tune various language models, recommendation systems, chat-bots, and the like. Any of the various generative language models discussed herein may be at least partially implemented via one or more transformer models. With reference now to the figures, example embodiments of the present disclosure will be discussed in further detail.

### Example Devices and Systems

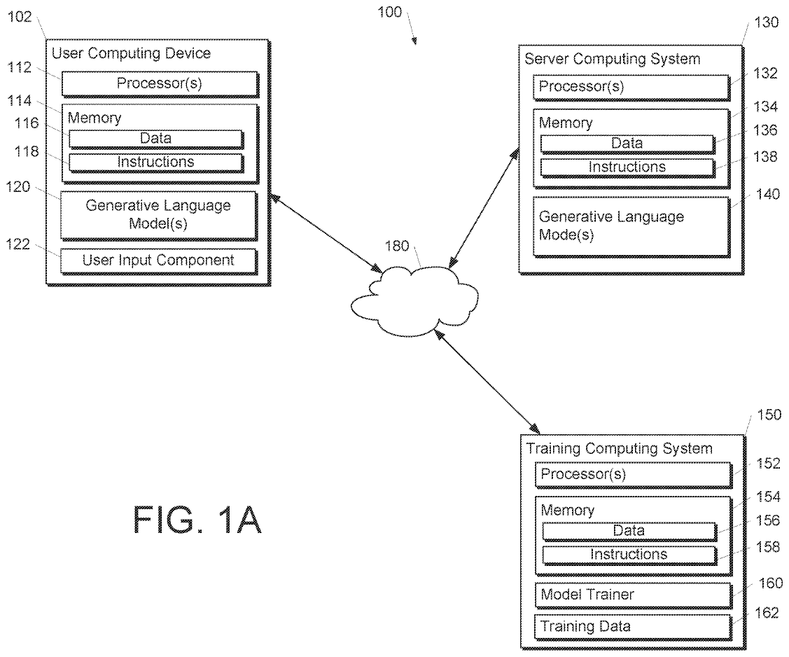

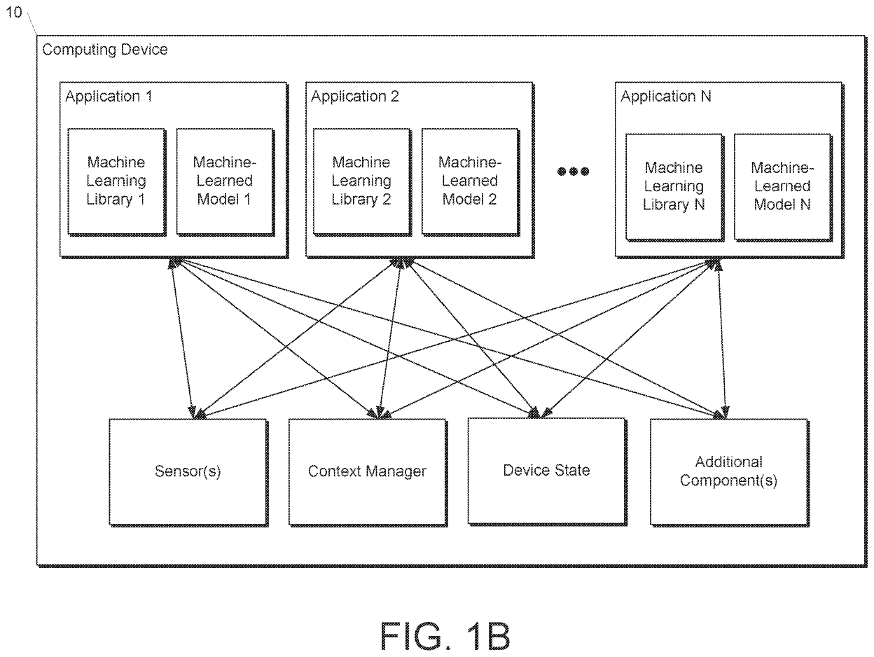

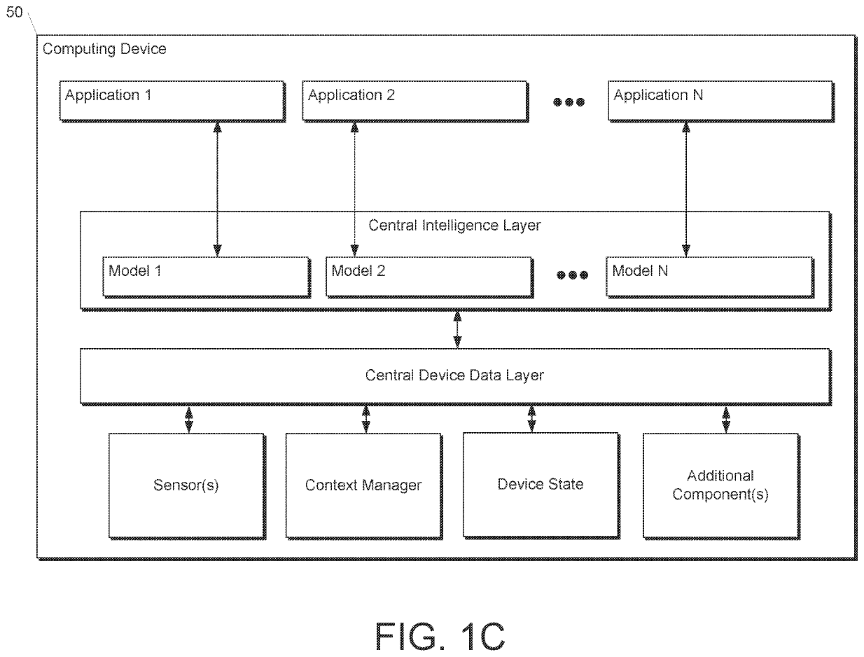

FIG. 1A depicts a block diagram of an example computing system 100 that is employ able to generate synthetic conversational data, according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

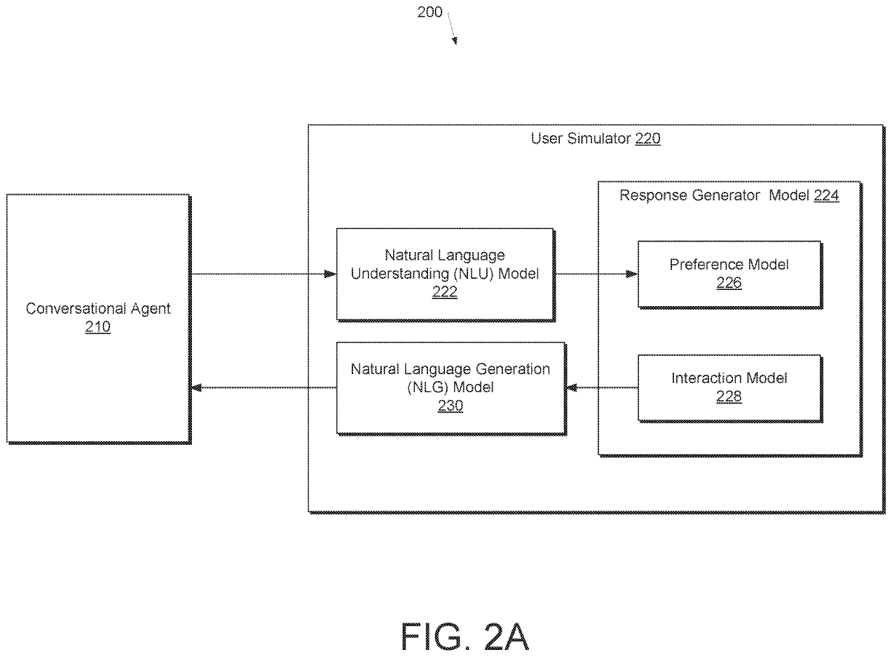

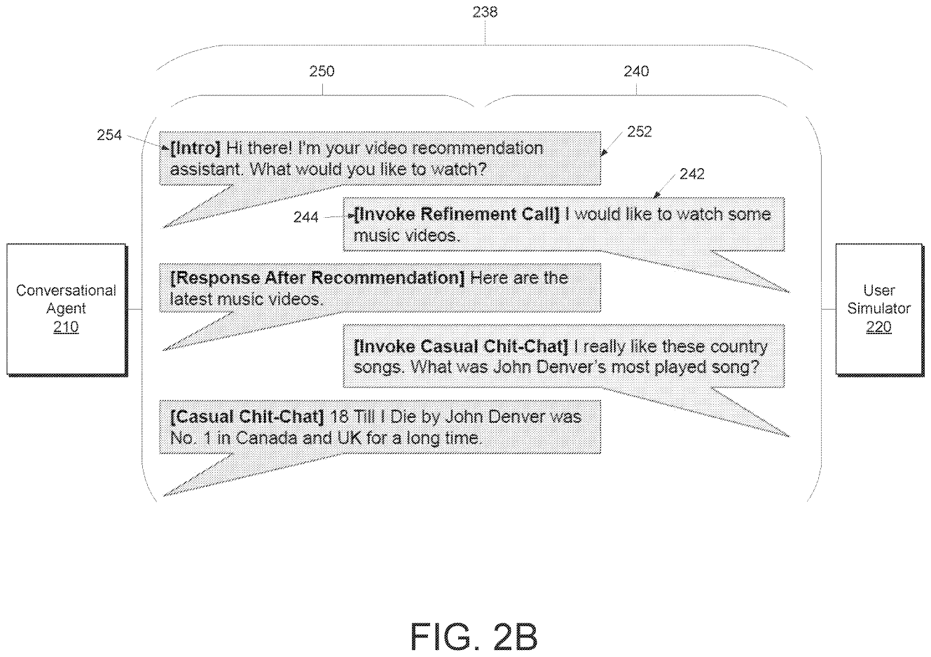

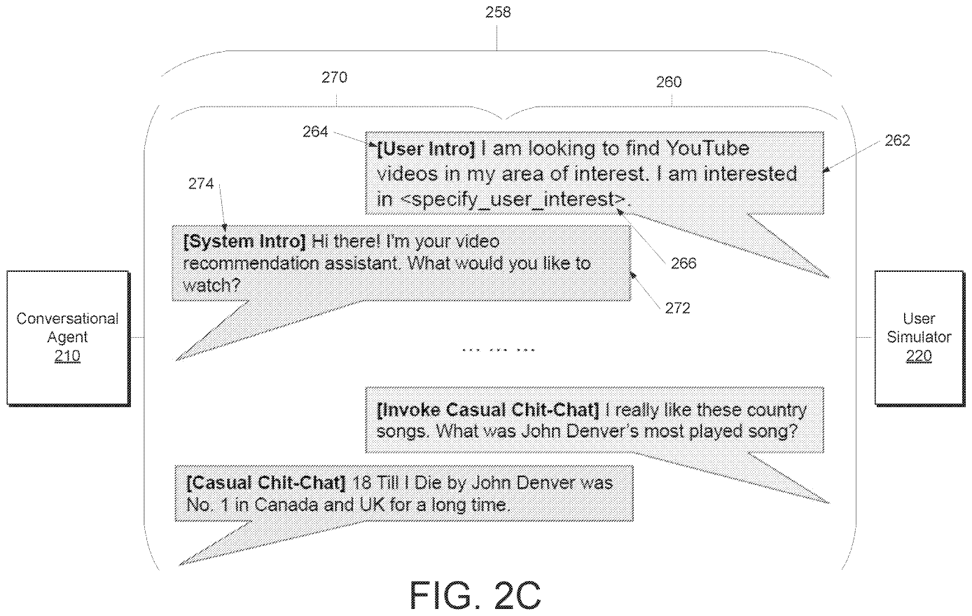

In some implementations, the user computing device 102 can store or include one or more generative language models 120. For example, the generative language models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example generative language models 120 are discussed with reference to FIGS. 2A-2C.

In some implementations, the one or more generative language models 120 can be received from the server computing system 130 over network 180, stored in the user computing device memory 114, and then used or otherwise implemented by the one or more processors 112. In some implementations, the user computing device 102 can implement multiple parallel instances of a single generative language model 120 (e.g., to perform parallel generation of synthetic conversational data across multiple instances of generative language models).

Additionally or alternatively, one or more generative language models 140 can be included in or otherwise stored and implemented by the server computing system 130 that communicates with the user computing device 102 according to a client-server relationship. For example, the generative language models 140 can be implemented by the server computing system 140 as a portion of a web service (e.g., a conversational data generation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more generative language models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the generative language models 120 and/or 140 based on a set of training data 162.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Synthetic Conversational Data Generation System Arrangements

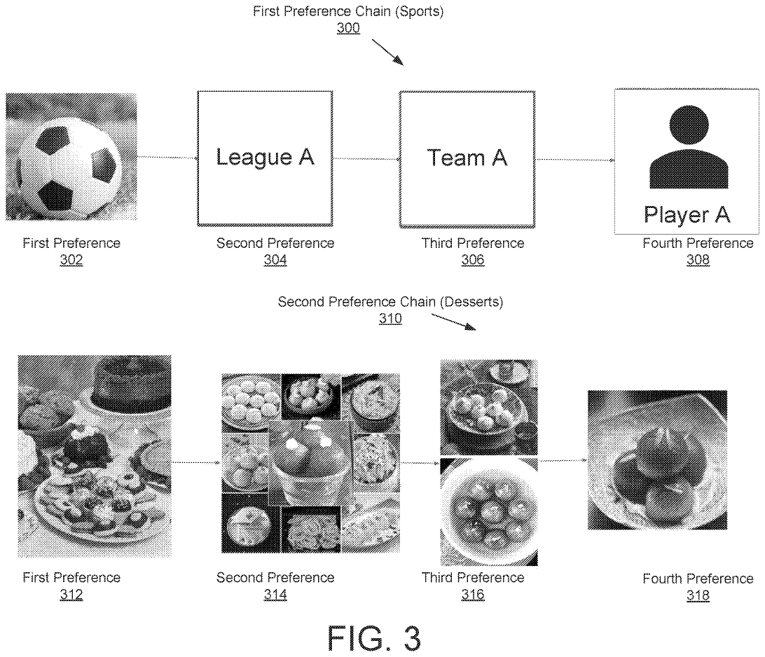

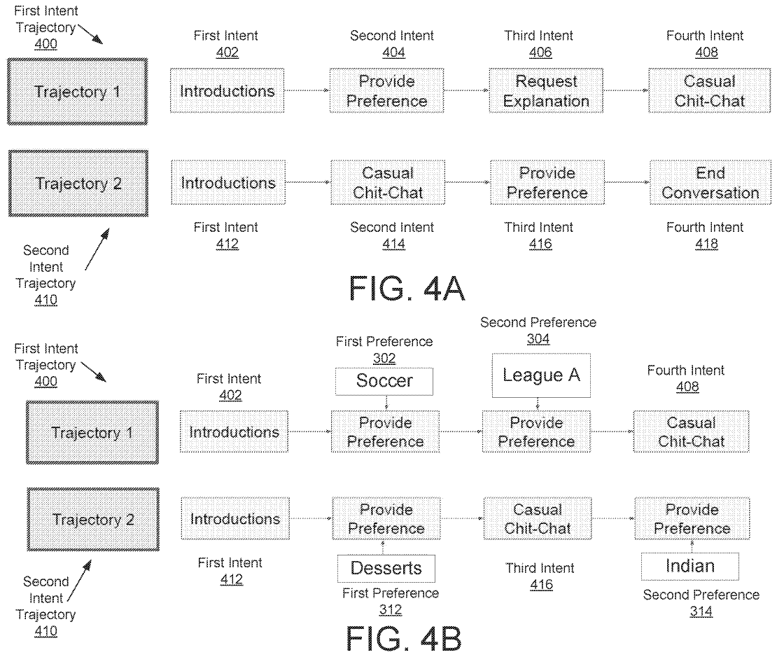

FIGS. 2A-4B will be discussed in conjunction with one another. FIG. 2A depicts a block diagram of an example synthetic conversational data generation system 200 that is enabled to generate synthetic conversational datasets, according to example embodiments of the present disclosure. FIG. 2B shows a first example of a synthetic conversational dataset (i.e., first synthetic conversational dataset) generated by the synthetic conversational data generation system 200 of FIG. 2A, according to various embodiments. FIG. 2C shows a second example of a synthetic conversational dataset (i.e., a second synthetic conversational dataset) generated by the synthetic conversational data generation system 200 of FIG. 2A, according to various embodiments. FIG. 3 shows a first example of a preference chain (e.g., first preference chain 300) and a second example of a preference chain (e.g., second preference chain 310), according to various embodiments. FIG. 4A shows a first example intent trajectory (i.e., first intent trajectory 400) and a second example intent trajectory (i.e., second intent trajectory 410), according to various embodiments. FIG. 4B shows combing the first and second example preference chains of FIG. 3 with the first and second example intent trajectories of FIG. 4A.

Returning to FIG. 2A, the synthetic conversational data generation system 200 of FIG. 2A may include a conversational agent 210 (e.g., a chat-bot employed by a recommendation system) and a user simulator 220. The user simulator 220 may be employed to simulate a user interacting with the conversational agent 210. When interacting, each of the conversational agent 210 and the user simulator 220 may generate synthetic (or artificial) conversational data, which may be collectively to as a synthetic conversational dataset (e.g., see the first synthetic conversational dataset of FIG. 2B and/or the second synthetic conversational dataset of FIG. 2C). That is, the conversational agent 210 and the user simulator 220 may proceed to have a synthetic (or artificial) conversation. Each of the conversational agent 210 and the user simulator 220 may generate separate and disjoint portions of the synthetic conversational dataset. As shown in FIGS. 2B-2C, the separate portions of the synthetic conversational dataset may alternate between the conversational agent 210 and the user simulator 220.

As discussed below, the user simulator 210 may implement a first generative language model and the conversational agent may implement a second generative language model. The generated synthetic conversational dataset generated via the conversation between the conversational; agent 210 (e.g., enabled via an implementation of a second generative language model) and the user simulator 220 (e.g., enabled via an implementation of a first generative language model) may be employed to evaluate (e.g., benchmark) a generative language model (e.g., the second generative language model implemented by the conversational agent 210). Such evaluation and/or benchmarking may include, but is not limited to, identifying gaps in the features (or performance) of the second language model or measuring improvements in the second generative language model. In at least one embodiment, the conversational dataset may be employed as a training data set to update the training (or fine-tune) the training of the second generative language model (e.g., training new features for the second language model). In some embodiments, the synthetic conversational dataset may be employed to train a third generative language model. In at least one embodiment, the conversation agent 210 may be replaced with another implementation (or another copy) of the user simulator 210, such that both sides of the synthetic conversation is generated by a user simulator 220.

To simulate a user, the user simulator 220 may be “tuned” or “configured” to a real or hypothetical user to be simulated. Tuning or configuring the user simulator 220 to simulate a real or hypothetical user may include “priming” or “seeding” the synthetic conversational by providing the user simulator 220 with a conversation topic (e.g., sports, desserts, music, and the like) of a set of conversation topics. For each conversation topic of the set of conversation topics, a preference chain may be defined and/or configured (e.g., see first preference chain 300 and second preference chain 310 of FIG. 3). A preference chain for a conversation topic may implement a dialogue state tracking (DST) model to define an ordered set of conversational states (or for the user simulator 220. Each increasingly consecutive state of the ordered set of conversational states may include or indicate an increasingly narrow preference for the conversation topic of the DST model. To further tune or configure the user simulator 220 to the user to be simulated by the user simulator 220, one or more intent trajectories (e.g., see FIG. 4A) may be defined for the simulated user. An intent trajectory may define an ordered set of conversational intents for the synthetic conversation. An intent trajectory may indicate an ordered template or schema of intentions for the synthetic conversation. As shown in FIG. 4B, preference chains and intent trajectories may be combined to finely-tune or configure the user simulator 220 to a real or hypothetical user. Preference chains and/or intent trajectories may also be provided to the conversation agent 210 to configure its generation of synthetic conversation data.

To generate its portion of the synthetic conversational dataset, the user simulator 220 may include (or implement) a natural language understanding (NLU) model 222, a response generator model 224, and a natural language generation (NLG) model 230. The response generator model 224 may include a preference model 242 and an interaction model 228. Because all these models work together to generate natural language (NL) phrases (e.g., phrases generated for the conversation between the conversation agent 210 and the user simulator 220), the models of the user simulator 220 may be collectively referred to as a first generative language model. The conversational agent 210 may include and/or implement a second generative language model (not shown in FIG. 2A). The functionalities and/or operations of these various models are discussed below.

Turning attention to FIG. 2B, a first synthetic conversational dataset generated by the conversational agent 210 and the user simulator 210 if FIG. 2A is shown. The first synthetic (or artificial) conversational dataset includes a first ordered set of synthetic (or artificial) natural language (NL) phrases 238. As used herein, a NL phrase may include a NL paragraph, a NL sentence, a NL sentence fragment, a NL token (e.g., a NL word and/or a character string) and/or an ordered set of NL tokens. An NL phrase may be considered an “atom” of a conversation and/or conversational data set. The first ordered set of (synthetic) NL phrases 238 may include a first ordered subset of synthetic NL phrases 240 and a second ordered subset of synthetic NL phrases 250. As shown in FIG. 2B, the first (ordered) subset of synthetic NL phrases 240 is generated by the user simulator 220 and the second (ordered) subset of synthetic NL phrases 250 is generated by the conversational agent 210. The first subset of (synthetic) NL phrases 240 includes at least a first synthetic NL phrase 242 and the second subset of (synthetic) NL phrases 250 includes at least a second synthetic NL phrase 252.

Note that the first ordered subset of NL phrases 240 and the second ordered subset of NL phrases 250 are disjoint and complementary subsets of the first ordered set of NL phrases 238. The order of the first set of ordered NL phrases 238 includes NL phrases that alternate between the first ordered subset of NL phrases 240 and the second ordered subset of NL phrases 250. In the embodiment shown in FIG. 2B, the conversational agent 210 generates the initial NL phrase (e.g., the second NL phrase 252) of the ordered set of NL phrases 238, while the user simulator 220 generates a synthetic response (e.g., the first NL phrase 242) to the initial NL phrase of the conversational agent 210. In other embodiments (e.g., see FIG. 2C), the user simulator 220 may generate the initial NL phrase of a synthetic conversational dataset. Except for the initial NL phrase (e.g., the second NL phrase 252), each NL phrase generated by the conversational agent 210 is generated in response to the immediate previous NL phrase generated by the user simulator 220. Likewise, each NL phrase generated by the user simulator 220 is generated in response to the immediate previous response generated by the conversational agent 210. For instance, the first NL phrase 242 generated by the user simulator 220 is generated in response to the initial NL phrase (e.g., the second NL phrase 252) generated by the conversational agent 210. Thus, a one-to-one correspondence between the first ordered subset of NL phrases 240 and the second ordered subset of NL phrases 250 may exist.

Each NL phrase of the first set of NL phrases 238 is annotated by an intentional element (e.g., first intentional element 244 of first NL phrase 242 and second intentional element 254 of second NP phrase 252) of an intent trajectory. Intent trajectories are discussed in conjunction with at least FIGS. 4A-4B. However, briefly here, each intentional element of an intent trajectory may indicate a classification (e.g., an NL phrase species or sub-species) of the corresponding NP phrase. That is, intentional elements may indicate a classification or labeling of an NL phrase according to one or more taxonomies of speech.

Intentional elements of an intent trajectory may be referred to as an intent.

Turning attention to FIG. 2C, a second synthetic conversational dataset generated by the conversational agent 210 and the user simulator 210 of FIG. 2A is shown. Like the first conversational dataset of FIG. 2B, the second synthetic (or artificial) conversational dataset includes a second ordered set of synthetic (or artificial) natural language (NL) phrases 258. The second ordered set of (synthetic) NL phrases 258 may include a first ordered subset of synthetic NL phrases 260 and a second ordered subset of synthetic NL phrases 270. As shown in FIG. 2C, the first (ordered) subset of synthetic NL phrases 260 is generated by the user simulator 220 and the second (ordered) subset of synthetic NL phrases 270 is generated by the conversational agent 210. The first subset of (synthetic) NL phrases 260 includes at least a first synthetic NL phrase 262 and the second subset of (synthetic) NL phrases 270 includes at least a second synthetic NL phrase 272.

Note that the first ordered subset of NL phrases 260 and the second ordered subset of NL phrases 270 are disjoint and complementary subsets of the first ordered set of NL phrases 258. The order of the first set of ordered NL phrases 258 includes NL phrases that alternate between the first ordered subset of NL phrases 260 and the second ordered subset of NL phrases 270. Unlike the synthetic (or simulated) conversation of FIG. 2B, the user simulator 220 generates the initial NL phrase (e.g., the first NL phrase 262) of the ordered set of NL phrases 258, while the conversational agent 210 generates a synthetic response (e.g., the second NL phrase 272) to the initial NL phrase of the user simulator 220. In other embodiments (e.g., see FIG. 2B), the conversational agent 210 may generate the initial NL phrase of a synthetic conversational dataset. Except for the initial NL phrase (e.g., the first NL phrase 262), each NL phrase generated by the user simulator 220 is generated in response to the immediate previous NL phrase generated by the conversational agent 210.

Likewise, each NL phrase generated by the conversational agent 210 is generated in response to the immediate previous response generated by the user simulator 220. For instance, the second NL phrase 272 generated by the conversational agent 210 is generated in response to the initial NL phrase (e.g., the first NL phrase 262) generated by the user simulator 220.

Thus, a one-to-one correspondence between the first ordered subset of NL phrases 260 and the second ordered subset of NL phrases 270 may exist.

Each NL phrase of the second set of NL phrases 258 is annotated by an intentional element (e.g., first intentional element 264 of first NL phrase 262 and second intentional element 274 of second NP phrase 272) of an intent trajectory. Intent trajectories are discussed in conjunction with at least FIGS. 4A-4B. However, briefly here, each intentional element of an intent trajectory may indicate a classification (e.g., an NL phrase species or sub-species) of the corresponding NP phrase. That is, intentional elements may indicate a classification or labeling of an NL phrase according to one or more taxonomies of speech. Intentional elements of an intent trajectory may be referred to as an intent.

Either the user simulator 220 or the conversational agent 210 may be “seeded” or “primed” via a conversation topic of a set of conversation topics. As shown in FIG. 2C, the conversation topic may indicate a user interest 266 of a real or hypothetical user. Such conversation topics may include, but are not limited to sports, desserts, movies, music, food, and the like.

Returning attention to FIG. 2A, the NLU model 222 of the user simulator 220 is generally responsible for determining a semantic meaning (or understanding) of NL phrases generated by the conversational agent 210. The response generator model 224 of the user simulator 220 is generally responsible for determining a preference and an intent for a response to an NL phrase provided by the conversational agent 210 based on the semantic understanding of the NL phrase, via a preference chain and an intent trajectory corresponding to the real or hypothetical user. More specifically, the preference model 226 is generally responsible for determining a preference for the response based on the semantic understanding, a state of the conversation, and the preference chain provided to the preference model 226. The preference model 226 may be referred to as a dialogue state tracking model and/or a conversation state tracking model. The interaction model 228 is generally responsible for determining an intention of the response based on the semantic understanding, the determined preference and an intent of an intent trajectory provided to the interaction model. As noted above, preference chains are discussed in conjunction with FIG. 3 and intent trajectories are discussed in conjunction with FIG. 4A. Combining both preference chains and intent trajectories are discussed in conjunction with FIG. 4B. The NLG model 240 of the user simulator generator 210 is generally responsive for generating a response (e.g., a NL phrase) based on the semantic understanding of the input NL phrase, as well as the preferences and intents determined by the preference model 226 and the interaction model 228. The NLG model 240 may also provide the generated response (e.g., a NL phrase) to the conversational agent 210 and/or another user simulator.

Turning attention to FIG. 3, FIG. 3 shows a first preference chain 300 and a second preference chain 310. The first preference chain corresponds to a first conversation topic (e.g., sports) and the second preference chain 310 corresponds to a second conversation topic (e.g., desserts). In general, a preference chain may include an ordered list of subjects (e.g., conversation topics). Each subject of a preference chain may be referred to as a preference. A first subject of the ordered list of subjects may corresponds to the conversation topic of the preference chain. Each subsequent subject of the ordered list may be a conversation topic may be a narrower version of a conversation topic of an immediately preceding subject on the ordered list of subjects. That is, the preference model 226 of FIG. 2A may determine narrower and narrower conversation topics based on a preference chain such that the ordered NL phrases generated by the user simulator 220 includes the ordered list of subjects in accordance with the preference chain. A preference chain may be generated based on a user profile for a real or hypothetical user.

For instance, the first preference 302 of the first preference chain 300, which corresponds to the conversation topic of sports, corresponds to soccer, which is a conversation topic that is narrower than the conversation topic of sports. Likewise, the second preference 304 of the first preference chain 300 corresponds to “League A” of soccer, which is a conversation topic that is narrower than the preceding conversation topic of soccer. The third preference 306 of the first preference chain 300 corresponds to “Team A” soccer team of “League A”, which is a conversation topic that is narrower than the preceding conversation topic of “League A”. The fourth preference 308 of the first preference chain 300 corresponds to the “Team A” player “Player A”, which is a conversation topic that is narrower than the preceding conversation topic of the “Team A” soccer team.

Likewise, the first preference 312 of the second preference chain 310, which corresponds to the conversation topic of desserts, corresponds to vegetarian desserts, which is a conversation topic that is narrower than the conversation topic of desserts. Likewise, the second preference 314 of the second preference chain 310 corresponds to Indian desserts, which is a conversation topic that is narrower than the preceding conversation topic of vegetarian desserts. The third preference 316 of the second preference chain 310 corresponds to sugar syrup Indian desserts, which is a conversation topic that is narrower than the preceding conversation topic of the Indian desserts. The fourth preference 318 of the second preference chain 310 corresponds to fried and sugar syrup Indian desserts, which is a conversation topic that is narrower than the preceding conversation topic of sugar syrup Indian desserts.

Turing attention to FIG. 4A, FIG. 4A shows a first example intent trajectory (i.e., first intent trajectory 400) and a second example intent trajectory (i.e., second intent trajectory 410), according to various embodiments. FIG. 4A shows a first intent trajectory 400 and a second intent trajectory 410. In general, an intent trajectory may define an ordered set of conversational intents (or intentional elements) for the synthetic conversation. An intent trajectory may indicate an ordered template or schema of intentions for the synthetic conversation. Each intentional element of an intent trajectory may indicate a classification (e.g., an NL phrase species or sub-species) of the corresponding NP phrase. That is, intentional elements may indicate a classification or labeling of an NL phrase according to one or more taxonomies of speech. Intentional elements of an intent trajectory may be referred to as an intent. Thus, intent trajectories (e.g., first intent trajectory 400 and second intent trajectory 410) may include an ordered list of NL phrase species. The operation of the user simulator 220 may be based on the intent trajectory such that the NL phrases that is generates are in accordance with the ordered list NL phrase species.

First intent trajectory 400 includes an ordered set of intentional elements (or intents): first intent 402, second intent 404, third intent 406, and fourth intent 408. Likewise, second intent trajectory includes an ordered set of intentional elements (or intents): first intent 412, second intent 414, third intent 416, and fourth intent 418. Other additional intents or intentional elements are shown in FIGS. 2B-2C (e.g., first intentional element 244 of first NL phrase 242 and second intentional element 254 of second NP phrase 252 of FIG. 2B and first intentional element 264 of first NL phrase 262 and second intentional element 274 of second NP phrase 272 of FIG. 2C).

FIG. 4B shows combing the first and second example preference chains of FIG. 3 with the first and second example intent trajectories of FIG. 4A. For the first intent trajectory 400, the first preference 302 (e.g., soccer) of first preference chain 300 is used for a response that corresponds to the second intent 404 (e.g., provide preference) of the first intent trajectory 400. Also, for the first intent trajectory 400, the second preference 304 (e.g., the “League A”) of first preference chain 300 is used for a response that corresponds to the third intent 404 (e.g., request explanation) of the first intent trajectory 400. Likewise, for the second intent trajectory 410, the first preference 312 (e.g., desserts) of second preference chain 310 is used for a response that corresponds to the second intent 414 (e.g., provide preference) of the second intent trajectory 410. Also, for the second intent trajectory 410, the second preference 314 (e.g., the Indian desserts) of second preference chain 310 is used for a response that corresponds to the fourth intent 418 (e.g., provide preference) of the second intent trajectory 410.

### Example Methods

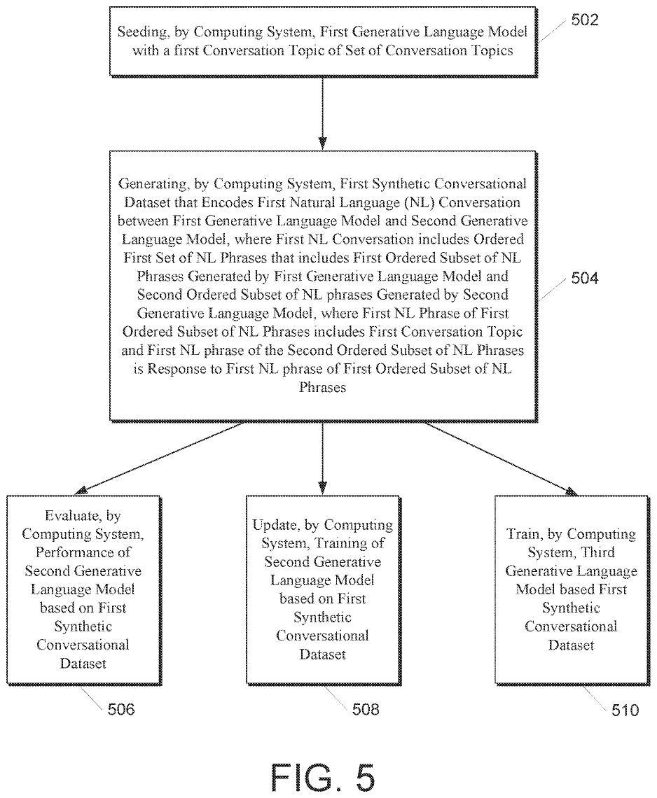

FIG. 5 depicts a flow chart diagram of an example method 500 to generate synthetic conversation data, according to example embodiments of the present disclosure.

Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, a first generative language model is seeded (or primed) at computing system. The first generative language model may be implemented by a user simulator (e.g., user simulator 220 of FIGS. 2A-2C). The first generative language model may include any of a natural language understanding (NLU) model (NLU model 222 of FIG. 2), a response generator model (e.g., response generator model 224 of FIG. 2), a preference model (e.g., preference model 226 of FIG. 2), an interaction model (interaction model 228 of FIG. 2), a natural language generation (NLG) model (e.g., NLG model 240 of FIG. 2), and/or a combination thereof.

At block 502, the first generative language model may be seeded by providing the first generative language model (or the user simulator) with a first conversation topic of a set of conversation topics. Providing the first conversation topic to the first generative language model may include providing a preference chain to the first generative language model. For instance, a preference chain may be provided to a preference model (e.g., preference model 226 of FIG. 2) of the first generative language model. Preference chains are discussed in conjunction with at least FIG. 3. However, briefly here, a preference chain may include an ordered list of subjects (e.g., preferences of FIG. 3). A first subject of the ordered list of subjects may correspond to the first conversation topic. Each subsequent subject of the ordered list may be a conversation topic that is a narrower version of a conversation topic of an immediately preceding subject on the ordered list of subjects. The preference chain may correspond to the first conversation topic. The preference chain may be generated based on a user profile of a real or hypothetical user.

Providing the first conversation topic to the first generative language model may include providing an intent trajectory to the first generative language model. Intent trajectories are discussed in conjunction with at least FIGS. 4A-4B. However, briefly here, an intent trajectory may include an ordered list of natural language (NL) phrases.

At block 504, a first synthetic conversational dataset may be generated at the computing system. Synthetic conversational datasets are discussed in conjunction with at least FIGS. 2B-2C. However, briefly here, the first synthetic conversational dataset may encode a first natural language (NL) conversation between the first generative language model and a second generative language model (or a user simulator and a conversational agent). The first NL conversation (or the first conversational dataset) may include an ordered first set of NL phrases (e.g., first ordered set of synthetic NL phrases 238 of FIG. 2B and/or second ordered set of synthetic NL phrases 258 of FIG. 2C).

The first set of NL phrases may include a first ordered subset of NL phrases (e.g., first ordered subset of synthetic NL phrases 240 of FIG. 2B and/or first ordered subset of synthetic NL phrases 260 of FIG. 2C). The first set of NL phrases may additionally include a second ordered subset of NL phrases (e.g., second ordered subset of synthetic NL phrases 250 of FIG. 2B and/or second ordered subset of synthetic NL phrases 270 of FIG. 2C). The first ordered subset of NL phrases may have been generated by the first generative language model (or the user simulator implementing the first generative language model). The second ordered subset of NL phrases may have been generated by the second generative language model (or the conversational agent implementing the second generative language model).

A first NL phrase (e.g., first NL phrase 240 of first ordered subset of synthetic NL phrases 240 of FIG. 2B and/or first NL phrase 260 of second ordered subset of synthetic NL phrases 260 of FIG. 2C) of the first ordered subset of NL phrases may include the first conversation topic. A first NL phrase (e.g., first NL phrase 250 of second ordered subset of synthetic NL phrases 250 of FIG. 2B and/or first NL phrase 270 of second ordered subset of synthetic NL phrases 270 of FIG. 2C) of the second ordered subset of NL phrases may be a response to the first NL phrase of the first ordered subset of NL phrases.

An order of the first ordered set of NL phrases may include NL phrases that alternate between the first ordered subset of NL phrases and the second ordered subset of NL phrases. The first ordered subset of NL phrases and the second ordered subset of NL phrases may be disjoint and complementary subsets of the first ordered set of NL phrases. The second generative language model may generate each NL phrase of the second ordered subset of NL phrases in response to a previous NL phrase of the first ordered subset of NL phrases generated by the first generative language model. Thus, a one-to-one correspondence between the first ordered subset of NL phrases and the second ordered subset of NL phrases may exist.

An operation of the first generative language model may be based on the provided preference chain. Thus, the NL phrases of the first ordered subset of NL phrases may include the ordered list of subjects in accordance with an order of the first ordered subset of NL phrases and an order of the ordered list of subjects. The operation of the first generative language model may additionally and/or alternatively be based on the intent trajectory. Thus, the NL phrases of the first ordered subset of NL phrases may be in accordance with the ordered list NL phrase species The second generative language model may be employed in a content recommendation system. In such embodiments, the second ordered subset of NL phrases may include at least one NL phrase that comprises one or more items of content based on the first conversation topic. In other embodiments, the second generative language model may be implemented by a chat-bot (e.g., conversational agent 210 of FIGS. 2A-2C). When the first generative language model is generating the first subset of NL phrases, the first generative language model may be simulating a user having the conversation with the chat-bot.

From block 504, method 500 may proceed to one or more of blocks 506, 508, and/or 510. At block 506, a performance of the second generative language model (or the conversational agent implementing the second generative language model) may be evaluated at the computing system. Evaluating the performance of the second generative language model may be based on the first synthetic conversational dataset. At block 508, a training of the second generative language model (or the conversational agent) may be updated at the computing system. Updating the training of the second generative language model may be based on the first synthetic conversational dataset. Updating the training of the second language model may include training a new feature of the second generative language model. At block 510, a third generative language model may be trained based on the first synthetic conversational dataset.

A set of synthetic conversational datasets may be generated via multiple implementations of blocks 502 and 504. The set of synthetic conversational datasets may include the first synthetic conversational dataset. The set if synthetic conversational datasets may be generated by employing the first generative language dataset and the second language dataset to have a set of NL conversations between the first generative language model and the second generative language model. Each synthetic conversational dataset of the set of synthetic conversational datasets may be directed to at least one conversation topic of the set of conversation topics. The implementation of any of blocks 506, 508, and/or 510 may be based on the set of synthetic conversational datasets.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method comprising:
providing, by a computing system, a first conversation topic of a set of conversation topics, to a first generative language model;
generating, by the computing system, a first synthetic conversational dataset that encodes a first natural language (NL) conversation between the first generative language model and a second generative language model, the first NL conversation including an ordered first set of NL phrases that includes a first ordered subset of NL phrases generated by the first generative language model and a second ordered subset of NL phrases generated by the second generative language model, wherein a first NL phrase of the first ordered subset of NL phrases includes the first conversation topic and a first NL phrase of the second ordered subset of NL phrases is a response to the first NL phrase of the first ordered subset of NL phrases; and
training, by the computing system, the second generative language model using the first synthetic conversational dataset.

2. The computer-implemented method of claim 1, the second generative language model is employed in a content recommendation system and the second ordered subset of NL phrases includes at least one NL phrase that comprises one or more items of content based on the first conversation topic.

3. The computer-implemented method of claim 1, wherein an order of the first ordered set of NL phrases includes NL phrases that alternate between the first ordered subset of NL phrases and the second ordered subset of NL phrases.

4. The computer-implemented method of claim 1, wherein the first ordered subset of NL phrases and the second ordered subset of NL phrases are disjoint and complementary subsets of the first ordered set of NL phrases.

5. The computer-implemented method of claim 1, wherein the second generative language model generates each NL phrase of the second ordered subset of NL phrases in response to a previous NL phrase of the first ordered subset of NL phrases generated by the first generative language model such that a one-to-one correspondence between the first ordered subset of NL phrases and the second ordered subset of NL phrases exists.

6. The computer-implemented method of claim 1, wherein providing the first conversation topic to the first generative language model comprises:
providing, by the computing device, a preference chain that includes an ordered list of subjects to the first generative model, wherein a first subject of the ordered list of subjects corresponds to the first conversation topic and each subsequent subject of the ordered list is a conversation topic that is a narrower version of a conversation topic of an immediately preceding subject on the ordered list of subjects.

7. The computer-implemented method of claim 6, further comprising:
operating, by the computing device, the first generative language model based on the preference chain such that the NL phrases of the first ordered subset of NL phrases includes the ordered list of subjects in accordance with an order of the first ordered subset of NL phrases and an order of the ordered list of subjects.

8. The computer-implemented method of claim 6, wherein the preference chain is generated based on a user profile.

9. The computer-implemented method of claim 1, wherein providing the first conversation topic to the first generative language model comprises:
providing, by the computing device, an intent trajectory that includes an ordered list of NL phrase species.

10. The computer-implemented method of claim 9, further comprising:
operating, by the computing device, the first generative language model based on the intent trajectory such that the NL phrases of the first ordered subset of NL phrases is in accordance with the ordered list NL phrase species.

11. The computer-implemented method of any preceding claim, wherein the second generative language model is implemented by a chat-bot.

12. The computer-implemented method of claim 11, wherein when the first generative language model is generating the first subset of NL phrases, the first generative language model is simulating a user having the conversation with the chat-bot.

13. The computer-implemented method of claim 1, further comprising:
generating, by the computing system, a set of synthetic conversational datasets that includes the first synthetic conversational dataset, by employing the first generative language dataset and the second language dataset to have a set of NL conversations between the first generative language model and the second generative language model, wherein each synthetic conversational dataset of the set of synthetic conversational datasets is directed to at least one conversation topic of the set of conversation topics; and
training, by the computing system, the second language model based on the set of synthetic conversational datasets.

14. A computer system configured to perform the method of any preceding claim.

15. (canceled)

16. (canceled)

17. A computer-implemented method comprising:
providing, by a computing system, a first conversation topic, of a set of conversation topics, to a first generative language model;
generating, by the computing system, a first synthetic conversational dataset that encodes a first natural language (NL) conversation between the first generative language model and a second generative language model, the first NL conversation including an ordered first set of NL phrases that includes a first ordered subset of NL phrases generated by the first generative language model and a second ordered subset of NL phrases generated by the second generative language model, wherein a first NL phrase of the first ordered subset of NL phrases includes the first topic and a first NL phrase of the second ordered subset of NL phrases is a response to the first NL phrase of the first ordered subset of NL phrases; and
training, by the computing system, the second generative language model using the first synthetic conversational dataset.

18. The computer-implemented method of claim 17, wherein training of the second language model includes updating the training of the second language model to include a new feature of the second generative language model.

19. A computer-implemented method comprising:
providing, by a computing system, a first conversation topic, of a set of conversation topics, to a first generative language model;
generating, by the computing system, a first synthetic conversational dataset that encodes a first natural language (NL) conversation between the first generative language model and a second generative language model, the first NL conversation including an ordered first set of NL phrases that includes a first ordered subset of NL phrases generated by the first generative language model and a second ordered subset of NL phrases generated by the second generative language model, wherein a first NL phrase of the first ordered subset of NL phrases includes the first topic and a first NL phrase of the second ordered subset of NL phrases is a response to the first NL phrase of the first ordered subset of NL phrases; and
training, by the computing system, a third generative language model based on the first synthetic conversational dataset.

20. (canceled)
